(19) United States
(12) Patent Application Publication
(10) Pub. No.: US 2015/0101216 A1
(43) Pub. Date: Apr. 16, 2015

(54) PLOW MECHANISM SPRING ASSEMBLY

(71) Applicants: Ronald W. KERR, Geneva, IL (US); Richard J. Beranek, Maple Park, IL (US)

(72) Inventors: Ronald W. KERR, Geneva, IL (US); Richard J. Beranek, Maple Park, IL (US)

(21) Appl. No.: 14/055,358

(22) Filed: Oct. 16, 2013

(51) Int. Cl. E01H 5/06; F16F 3/04

(52) U.S. Cl. CPC E01H 5/063; F16F 3/04
USPC 37/232; 267/150

(57) ABSTRACT

A spring assembly defining an elongated axis and includes an axially elongated connector articulately connected toward a first end to a first member and articulately connected toward a second end to a second member for joining and permitting pivotal movements between the first and second members. Two springs are arranged axially relative to each other along and about the connector between the first and second ends thereof. An alignment member is disposed between the two springs for aligning adjacent ends of the two springs relative to each other and relative to an elongated axis of the spring assembly. The alignment member defines a generally centralized opening adapted to slidably move along and relative to the connector.

### FIELD OF THE INVENTION DISCLOSURE

The present invention disclosure generally relates to a spring assembly for a plow mechanism and, more particularly, to a plow mechanism spring assembly having two axially arranged springs with an alignment guide disposed therebetween for aligning adjacent ends of the springs relative to each other and relative to an elongated axis of the spring assembly

### BACKGROUND

Spring assemblies are used in myriad of different environments. In one form, spring assemblies are used in connection with plows on railcars. In another form, spring assemblies are known to be used in combination with snow plows on light and medium trucks. The business of manufacturing plows for trucks is highly competitive, with manufacturers differentiating themselves based on features and enhanced technology they design into their products.

When plowing a street or parking lot, it is not infrequent for a lower edge of the plow to strike an object which is concealed beneath the snow. This occurs particularly often when a displaced manhole/sewer cover is forcibly struck or engaged during a plowing operation. Alternatively, the plow blade can strike various objects while plowing a road which is not paved, for example, gravel or dirt roads. Since the roads being plowed are typically frozen, it is common for an object of significant size to become frozen into the road. As an example, medium size rocks which would normally not pose a problem when laying loose on the road, can and often do present a problem, when they are frozen into the surface of the road and concealed beneath a layer of snow. Additionally, when the snow fall accumulates, it tends to hide or otherwise conceal obstacles such a curbs, dividers and the like, which an operator may not see or can misconstrue the significance thereof resulting in the snow plow being mistakenly driven thereinto sometimes with considerable force.

Accordingly, snow plow blades have been manufactured with a blade trip mechanism. Such a mechanism allows the plow blade to pivot or otherwise rotate so as to allow the plow blade to yield upon substantial impact with an object. That is, and upon striking an object and/or obstruction, such a mechanism permits a bottom of the snow plow blade to pivot rearwardly from a normal plowing position. Simultaneously, and as the bottom of the snow plow blade pivots rearwardly, the top of the snow plow blade moves forward from the normal plowing position.

Movement between the normal plowing position of the snow plow blade to a position in which the bottom of the snow plow blade pivots rearwardly or backward is commonly referred to as blade tripping. Movements of the snow plow blade from a normal plowing position to a “blade tripped” position is resisted by two or more trip springs mounted behind the snow plow blade. Each spring extends from a position wherein the spring is connected toward a top of the snow plow blade to frame structure used to connect the plow blade to a vehicle. When the bottom of the snow plow blade is forced backward, the springs provide a strong resistance to the movement while tending to absorb some of the impact forces of the of the snow plow blade with the object which has been engaged and struck.

When the force causing the snow plow blade to trip are removed, i.e, after the object being struck has been overcome, the springs forcibly urge the snow blade to return to the normal plowing position, also referred to as the “blade return” position. Since it is not desirable for the snow plow blade to be easily moved from the normal plowing position when plowing snow, the springs are quite strong. Moreover, and depending upon the size or height of the snow blade and the location on the frame wherein the springs are connected thereto, the springs often have an extended length. Although necessary for proper operation of the plow assembly, their extended length coupled with the strength required thereof makes such springs expensive.

Thus, there is a continuing need and desire for an elongated spring assembly which provides both the necessary strength and durability and yet is economical to produce and replace whereby reducing maintenance costs associated with such plows.

### SUMMARY

In view of the above, and in accordance with one aspect of this invention disclosure, there is provided an axially elongated spring assembly for releasably maintaining a plow blade in a predetermined position about a generally horizontal axis. The spring assembly includes an elongated retractable/extendable connector arranged in general coaxial alignment with an elongated axis of the spring assembly. A first end of the connector is operably connected to the plow blade at a location disposed above the generally horizontal axis; with a second end being operably connected to a plow blade frame. Two springs, arranged in axial relation relative to each other, are disposed between the first and second ends of and along the connector. An alignment member is disposed between adjacent ends of the two springs. The alignment member defines a generally centralized opening so as to permit the guide to slidably move along and relative to the connector while maintaining alignment of adjacent ends of the two springs relative to each other and relative to the elongated axis defined by the spring assembly.

Preferably, each spring of the spring assembly is formed from an axially elongated one-piece elastomeric material defining an elongated bore opening to opposed ends thereof. The elongated bore defined by each spring preferably has a closed margin about a diameter thereof. In one form, the each spring has a plurality of axially spaced flange sections along a length thereof, with any two axially adjacent flange sections on each spring being axially separated by an axially elongated energy absorption section for allowing each spring to react to energy imparted thereto during operation of said spring assembly.

In one embodiment, the alignment member defines an opening extending therethrough, with a marginal edge of the opening having a cross-sectional configuration which proximates a cross-sectional configuration of the elongated connector. Each spring of the spring assembly has interior and exterior surfaces In this form, the alignment member has a body portion with projections axially extending away from opposed and generally parallel surfaces on the body portion and arranged in generally concentric relation with the elongated axis defined by said spring assembly. Each projection on the alignment member preferably defines an exterior surface sized to axially extend within and operably engage the interior surface of a respective spring to affect alignment between the adjacent ends of the two springs relative to each other and relative to the elongated axis defined by the spring assembly

According to another aspect of this invention disclosure, there is provided biasing structure arranged in combination with a plow blade assembly having a frame defining a longitudinal axis. The frame mounts a plow blade for pivotal movement about a generally horizontal axis between a blade return position and a blade tripped position. The biasing structure urges the plow blade from the blade tripped position toward the blade return position and includes a pair of laterally spaced spring assemblies disposed to opposed lateral sides of the longitudinal axis defined by the plow blade frame. Each spring assembly includes an extendable/retractable connector defining an elongated axis. A first end of the connector is operably joined to the plow blade above the axis about which the plow blade pivots and a second end of the connector is operably joined to the frame. First and second end-to-end springs are arranged in operable combination with and along a lengthwise portion of each connector for biasing the plow blade from the blade tripped position toward the blade return position. An alignment member is disposed between the first and second springs of each spring assembly for aligning adjacent ends of the springs relative to each other and relative to the elongated axis of the connector. The alignment member defines a generally centralized opening adapted to slidably move along and relative to the connector.

In one form, the springs of each spring assembly are formed from an axially elongated one-piece elastomer defining an elongated bore opening to opposed ends thereof. The elongated bore defined by each compression spring preferably has a closed margin. In the illustrated embodiment, each spring has a plurality of axially spaced flange sections along a length thereof, with any two axially adjacent flange sections on each spring being axially separated by an axially elongated energy absorption section for allowing each spring to react to energy imparted thereto during operation of the spring assembly.

The opening in the alignment member of each spring assembly preferably has a marginal edge with a cross-sectional configuration which proximates a cross-sectional configuration of the respective elongated connector. Also, the spring of each spring assembly has interior and exterior surfaces. Moreover, in one form, the alignment member of each spring assembly has a body portion with projections axially extending away from opposed and generally parallel surfaces on the body portion and arranged in generally concentric relation with the elongated axis defined by the respective spring assembly. In one form, the projections on the alignment member of each spring assembly each define an exterior surface sized to axially extend within the interior surface of a respective spring to effect alignment between the opposed ends of the two springs of the respective spring assembly relative to each other and relative to the elongated axis defined by the spring assembly

According to yet another aspect, there is provided an axially elongated spring assembly defining an elongated axis and includes an elongated multipiece connector whose first end is articulately joined to a first member and articulately joined toward a second end to a second member to permit pivotal movements between the first and second members. Two springs are arranged axially relative to each other along and about the connector between the first and second ends thereof. An alignment member is disposed between the two springs to effect alignment of adjacent ends of the two springs relative to each other and relative to an elongated axis of the spring assembly. The alignment member defines a generally centralized opening adapted to slidably move along and relative to the elongated connector.

In one form, each spring is formed from an axially elongated one-piece hollow elastomer opening to opposed ends. The elongated bore defined by each spring preferably has a closed margin about a diameter thereof. In a preferred form, each spring has a plurality of axially spaced flange sections along a length thereof, with any two axially adjacent flange sections on each spring being axially separated by an axially elongated energy absorption section for allowing each spring to react to energy imparted thereto during operation of said spring assembly.

Preferably, a marginal edge of the opening in the alignment member of each spring assembly has a cross-sectional configuration which proximates a cross-sectional configuration of the elongated connector. Moreover, each spring has interior and exterior surfaces In one embodiment, the alignment member has a body portion with projections axially extending away from opposed and generally parallel surfaces on the body portion and arranged in generally concentric relation with the elongated axis defined by the spring assembly. The projections on the alignment member preferably defines an exterior surface sized to axially project within the interior surface of a respective spring to affect alignment between the opposed ends of the two springs relative to each other and relative to the elongated axis defined by the spring assembly

### DESCRIPTION OF THE DRAWINGS

FIG. 1 is a side elevatonal view of a spring assembly in accordance embodying principals and teachings of this invention disclosure forming part of a plow assembly mounted to a light duty vehicle such as a pick-up truck;

FIG. 2 is a fragmentary top plan view of the plow assembly shown in FIG. 1;

FIG. 3 is a schematic and enlarged side elevational view showing a plow blade in a lower operating position;

FIG. 4 is a schematic view similar to FIG. 3 showing the plow blade in a raised and deflected position;

FIG. 5 is a plan view of an alignment guide forming part of the present invention disclosure; and

FIG. 6 is a cross-sectional view taken along line 6-6 of FIG. 5.

### DETAILED DESCRIPTION

While this invention disclosure is susceptible of embodiment in multiple forms, there is shown in the drawings and will hereinafter be described a preferred embodiment, with the understanding the present disclosure sets forth an exemplification of the disclosure which is not intended to limit the disclosure to the specific embodiment illustrated and described.

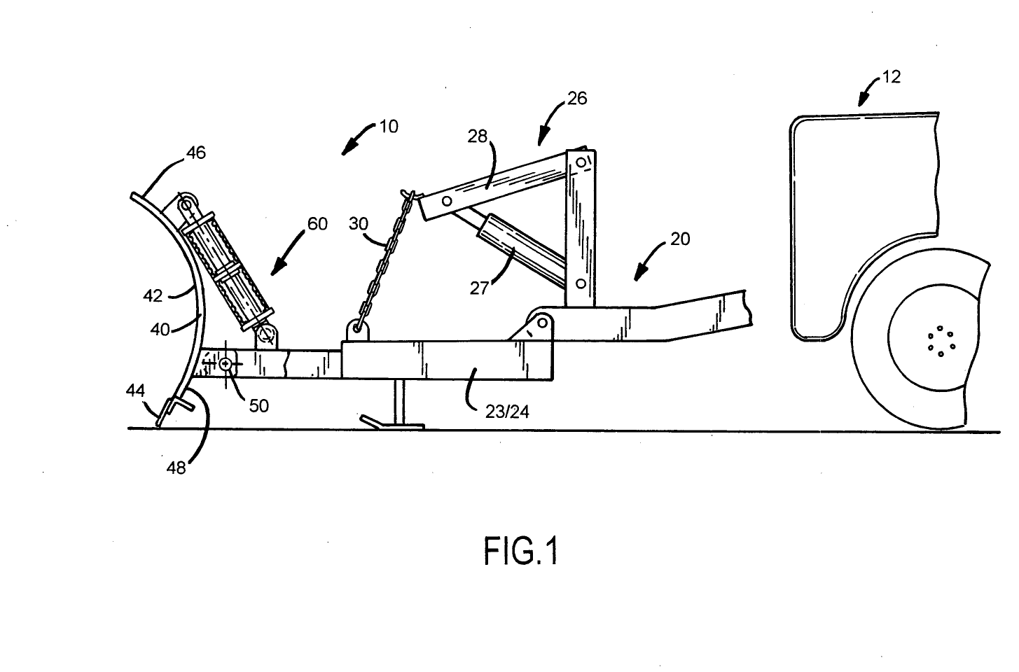

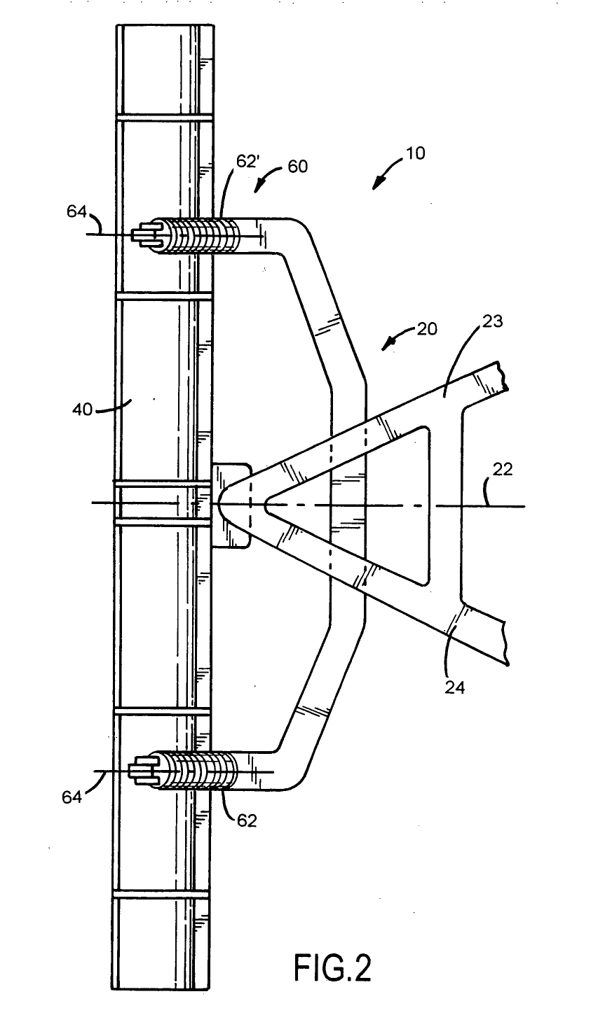

Referring now to the drawings, wherein like reference numerals indicate like parts throughout the several views, there is shown in FIGS. 1 and 2 a plow assembly, generally indicated by reference numeral 10, which includes a universal mounting or frame assembly 20 having a plow blade 40 connected toward a forward end thereof. Although the present invention disclosure is shown for illustrative purposes as part of a plow assembly which, in turn, is mounted or otherwise connected to a front end of a vehicle, generally identified by reference numeral 12 (FIG. 1), it should be appreciated the principals and teachings of the present invention disclosure can find utility in applications and uses other than that shown.

Frame assembly 20 is of a conventional design. In the embodiment illustrated for exemplary purposes, and as shown in FIG. 2, the frame assembly 20 for operably connecting the plow blade 40 to the vehicle 12 (FIG. 1) defines a longitudinal axis 22 and includes a pair of arms 23, 24 arranged in a generally V-shape relative to each other and which permit the plow blade 30 to be raised and lowered, when required or desired. To affect such ends, and as shown in FIG. 1, frame assembly 20 includes a conventional lift mechanism 26 including a distendable/retractable driver 27 attached to a pivotal lever 28. In one form, one end of a chain 30 is operably connected toward a free or distal end of the lever 28. The other end of the chain 30 is connected to the frame arms 23, 24. Selective operation of the driver 27 causes the arms 23, 24 to pivot whereby raising and lowering the plow blade 40 to a desired position.

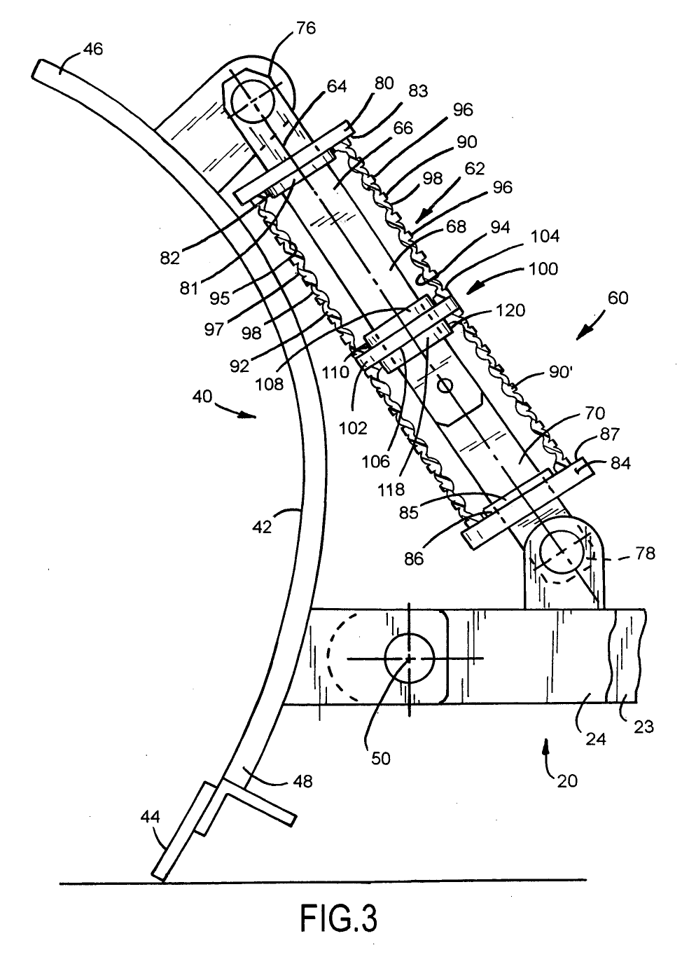

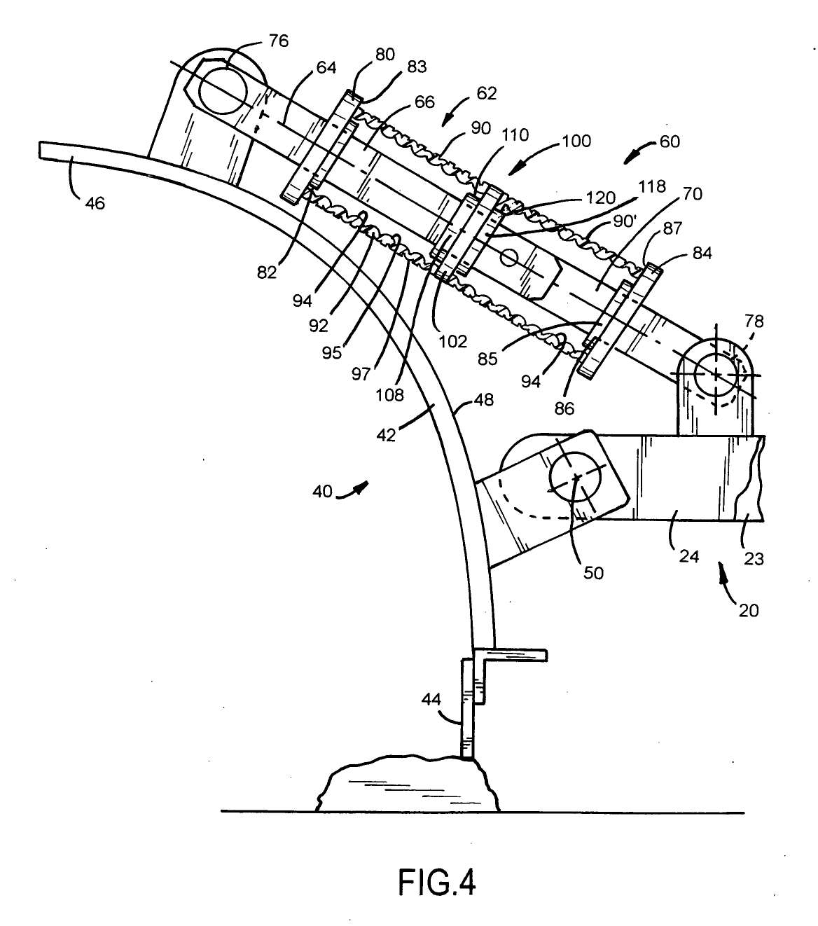

The plow blade 40 has a front clearing surface 42, concave in the direction of movement, a lower scrapper edge 44, an upper edge 46, and a rear side or surface 48. The blade 40 is attached toward a front of the frame assembly 20 in a conventional and well known manner so as to permit the plow blade 40 to pivot about a generally horizontal axis 50 located to the rear side 48 of the plow blade 40. Suffice it to say, the plow blade 40 is mounted to the frame assembly 20 such that it may pivot between a blade trip return position, shown in FIG. 3, and a blade tripped position, shown in FIG. 4.

It will be appreciated by those skilled in the art, and during operation of the plow assembly 10, when the edge 44 of the plow blade 40 strikes or hits an object on the ground sufficiently hard, it will be driven from the blade return position shown in FIG. 3 to the blade tripped position shown in FIG. 4. That is, in the event the blade 40 strikes an obstruction sufficiently hard, the lower edge 44 moves upward and pivots rearward about axis 50 while the upper edge 46 will pivot or rotate forward about axis 50 as the plow 40 is driven from the blade return position shown in FIG. 3 to the blade tripped position shown in FIG. 4. This forward tilt allows blade 40 to slide up and over the obstruction.

To bias plow blade 40 toward the blade return position (FIG. 3) and to resist movement of the plow blade into the blade tripped position (FIG. 4), biasing structure 60 is arranged in operable combination with blade 40. In the embodiment shown in FIG. 2, biasing structure 60 includes first and second spring assemblies 62 and 62′ preferably arranged generally parallel to each other and to opposed lateral sides of the longitudinal axis 22 of frame assembly 20. It will be appreciated, more than two spring assemblies can be utilized to form the biasing structure 60 if so desired without detracting or departing from the spirit and scope of this invention disclosure. Preferably, the spring assemblies 62, 62′ are substantially similar relative to each other and, thus, only spring assembly 62 will be described in detail.

In the embodiment shown in FIG. 3, each spring assembly defines an elongated axis 64 and includes an elongated retractable/extendable connector 66 preferably arranged in general coaxial alignment with the elongated axis 64 of the spring assembly. Suffice it to say, connector 66 is designed and constructed to permit movement of the blade 40 between the blade return position (FIG. 3) and the blade tripped position (FIG. 4). Preferably, and as shown in FIG. 2, the axis 64 of each spring assembly 62, 62′ is disposed generally parallel to the longitudinal axis 22 of frame assembly 20. As such, the spring assemblies 62, 62′ preferably do not pull in a direction which is at an angle relative to the longitudinal axis 22 of the frame assembly 20. Such a design offers a major advantage over previously known spring arrangements which are disposed at an angle relative to the longitudinal axis 22 of the frame assembly. By arranging the spring assemblies generally parallel to the longitudinal axis 22 of frame assembly 20 substantially all the spring force of the spring assemblies is utilized for the blade trip operation. Such a design provides more consistent blade trip operation. Moreover, such design eliminates almost all lateral trip spring force from being exerted on the frame assembly 20 of the plow assembly.

In the illustrated embodiment, connector 66 is of multipiece construction and includes a first axially elongated member or piece 68 which is operably joined or otherwise attached to a second axially elongated piece 70. The connector pieces 68, 70 are operably interconnected to each other so as to permit extension/retraction of each spring assembly during operation of the plow assembly 10.

As illustrated in FIGS. 3 and 4, a first end 76 of connector 66 is operably and articulately joined or attached to the plow blade 40 at a location disposed above the horizontal axis 50 about which the blade 40 pivots. A second end 78 of connector 66 is operably and articulately connected to the frame assembly rearward of the rear side 48 of plow blade 40.

As shown in FIG. 3, and spaced axially away from that end 76 articulately connected to blade 40, connector piece 68 is provided with a first fixed radial flange or stop 80. Similarly, and spaced axially away from that end 78 articulately connected to frame assembly 20, connector piece 70 is provided with a second fixed radial flange or stop 84 disposed in axially spaced relation from stop 80. The axial distance between flanges 80 and 84 on connector 66 can vary depending upon any of a number of factors. That is, the axial distance between flanges 80 and 84 on connector 66 can vary depending upon the particular plow design. Moreover, the axial distance between the connector flanges 80 and 84 can vary depending upon the obstruction being struck and the disposition of the plow blade when it reaches the blade tripped position. Suffice it to say, the axial distance separating the flanges 80 and 84 on connector 66 can range between about 24 inches and about 40 inches during operation of the plow blade assembly 10.

In one form, the radial flange or stop 80 is arranged generally coaxial with the longitudinal axis 64 of the respective spring assembly and defines a projection 81 extending axially inward toward a longitudinal center of the respective spring assembly. In the illustrated embodiment, the projection 81 defines a radial shoulder 82 having an outside diameter which is smaller than an outer diameter of stop 80 so as to allow the projection 81 to axially extend within an interior of a spring 90 and provides the stop 80 with a step 83.

In one form, the radial flange or stop 84 is arranged generally coaxial with the longitudinal axis 64 of the respective spring assembly and defines a projection 85 extending axially inward toward a longitudinal center of the respective spring assembly. In the illustrated embodiment, the projection 85 defines a radial shoulder 86 having an outside diameter which is smaller than an outer diameter of stop 84 so as to allow the projection 85 to axially extend within the interior of the interior of a spring 90′ and provides the stop 84 with a step 87.

As shown in FIG. 3, operably disposed between the opposed ends of connector 66, each spring assembly 62 includes first and second axially aligned springs 90 and 90′. It should be appreciated, however, if and when required, each spring assembly can include more than two springs arranged in end-to-end relationship without detracting or departing from the spirit and scope of this invention disclosure. In the illustrated embodiment, springs 90, 90′ are designed as compression springs that are axially arranged in operable combination with and between the stops 80 and 84 on connector 66 such that springs 90, 90′ extend along and about a lengthwise portion of the connector 66 and bias the plow blade 40 from the blade tripped position (FIG. 4) toward the blade return position (FIG. 3).

As shown, springs 90, 90′ are substantially similar in design relative to each other and, thus, only spring 90 will be described in detail. Preferably, each spring has an axially elongated body 92 with a generally cylindrical configuration between opposed ends. Moreover, each spring is generally hollow and defines an elongated bore 94 opening to opposed ends of the respective spring whereby providing each spring with interior 95 and exterior surfaces 97. As shown, the bore 94 defined by each spring has a closed margin about a diameter thereof. Although not specifically shown, it should be appreciated, the principals and teachings of the present invention disclosure equally apply to metal coil springs.

In the preferred form, each spring 90, 90′ is formed from an axially elongated one-piece thermoplastic ether ester elastomer. In the illustrated embodiment, each spring 90, 90′ is provided with a plurality of axially spaced flange sections 96 along a length thereof. Preferably, the flange sections 96 of each spring 90, 90′ has a generally constant outside diameter. As shown in FIG. 3, any two flange sections 96 on each spring 90, 90′ are axially separated by an energy absorbing section 98 for allowing the spring to react to energy imparted thereto during operation. Each energy absorbing section or convolute 98 of each spring 30 preferably has the form of a ring whose lateral outer face is curved toward an exterior of the respective spring.

The thermoplastic ether ester elastomer used to form springs 90, 90′ is initially created as a preform. An elastomer having tensile characteristics such that the ratio of plastic strain to elastic strain is greater than 1.5 to 1 has proven particularly beneficial. The preferred elastomer is one manufactured and sold by E.I. duPont de Nemoirs under the trademark Hytrel®. Notably, however, suitable elastomer materials other than Hytrel® would equally suffice without detracting or departing from the spirit and scope of this disclosure. Notably, the elastomer material forming the elastomer is free of spring-like characteristics. For a more complete description of transmuting such elastomer material into a spring, attention is directed to U.S. Pat. No. 4,198,037 to D. G. Anderson and/or U.S. Pat. No. 5,141,697 to N. E. Wydra; with applicable portions of either and/or both references being incorporated herein by reference.

Preferably, the elastomer used to form springs 90, 90′ has a molecular structure and a Shore D durometer hardness ranging between about 40 and 60. In the preferred embodiment, the elastomer used to form springs 90, 90′ has a Shore D durometer of about 55. Significantly, such elastomer is quite durable and has an excellent flex life. Moreover, such elastomer is not subject to tearing or to crack propagation even in relatively thin cross-sections. Additionally, such an elastomer is known to work well in a wide range of temperature variants

Preferably, and after being arranged in operable combination with spring 90, the step 83 on stop 80 operably engages and acts as a seat for an outer end of spring 90. Moreover, and after being arranged in operable combination with spring 90, projection 81 on stop 80 will axially extend into the interior of spring 90 such that the outer diameter of the projection 81 generally aligns one end of spring 90 relative to the elongated axis 64 of the respective spring assembly. Similarly, and after being arranged in operable combination with spring 90′, the step 87 on stop 84 operably engages and acts as a seat for an outer end of spring 90′. Moreover, and after being arranged in operable combination with spring 90′, projection 85 on stop 84 axially extends into the interior of spring 90′ such that the outer diameter of the projection 84 generally aligns one end of spring 90′ relative to the elongated axis 64 of the respective spring assembly. Notably, an outer diameter of each stop 80, 87 is larger than the outer diameter of each spring 90, 90, respectively.

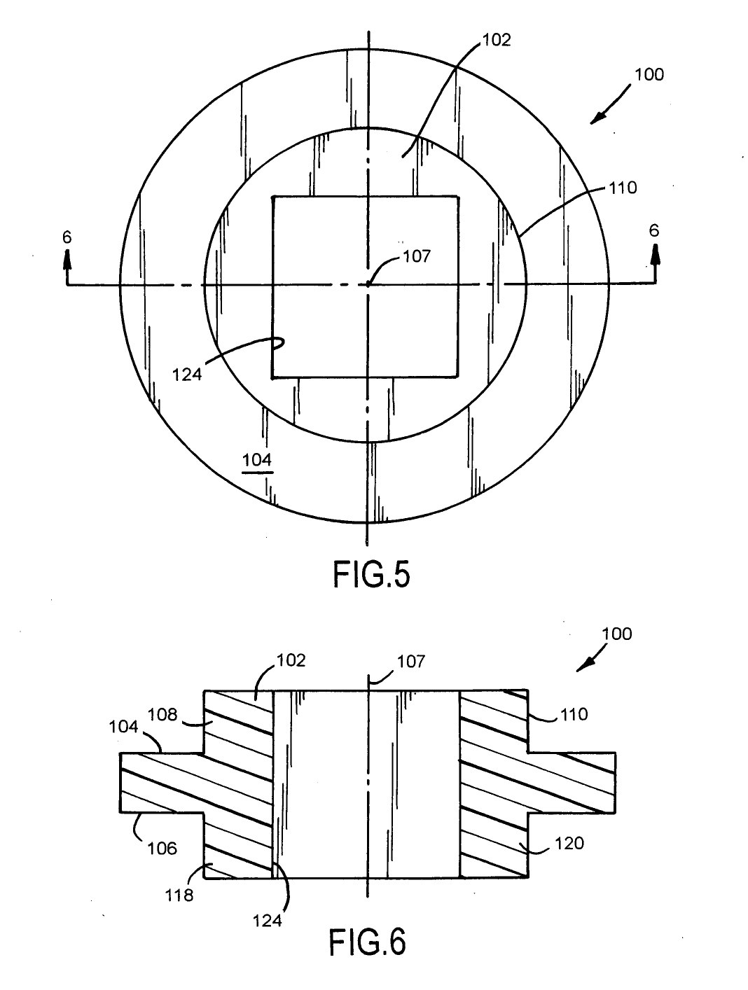

After being arranged about and along the respective connector 66, and to advantageously align axially adjacent inner ends of the springs 90, 90′ relative to each other and relative to the elongated axis 64 of each spring assembly whereby optimizing performance of the biasing structure 60, each spring assembly furthermore includes an alignment member 100. In the embodiment shown in FIGS. 5 and 6, alignment member 100 includes a body portion 102 having an outer diameter generally equal to or somewhat larger than the outer diameter of each spring 90, 90′.

Alignment member 100 further includes projections 108 and 118 axially extending away from opposed and generally parallel surfaces 104 and 106 of the body portion 102. The generally parallel surfaces 104 and 106 on alignment member 100 preferably engage and acts as seats for an inner end of springs 90, 90′, respectively. Notably, in a preferred form, the body portion 102 defines a centralized axis 107 with the projections 108 and 118 being arranged in generally concentric relation relative to the centralized axis 107. Projection 108 has a diameter smaller than an outside diameter of member 100. As such, projection 108 defines a radial shoulder 110 with a diameter equal to or slightly smaller than the interior surface 95 of spring 90. Similarly, projection 118 has a diameter smaller than an outside diameter of member 100. As such, projection 118 defines a radial shoulder 120 having a diameter equal to or slightly smaller than the interior surface 95 of spring 90′.

As shown in FIGS. 5 and 6, alignment member 100 further define a generally centralized opening 124 extending through the body portion 102, through the projections 108 and 118, and opening to opposed sides of member 100. The opening 124 has a predetermined marginal configuration which preferably proximates the cross-sectional configuration of the connector 66 (FIGS. 3 and 4) extending axially therethrough. As such, and when mounted in operable combination with the respective spring assembly of biasing structure 60 (FIGS. 3 and 4), the alignment member 100 is permitted to slide along the length of the connector 66 while maintaining a predetermined rotational orientation with respect to the connector 66. In FIGS. 5 and 6, the marginal configuration of opening 124 is illustrated as being generally square. It should be appreciated, however, the marginal configuration of opening 124 can be other than square i.e. triangular, rectangular, oval and etc without detracting or departing from the spirit and scope of this invention disclosure.

As shown in FIGS. 3 and 4, when arranged in operable combination with springs 90, 90′ of each spring assembly, projection 108 on alignment member 100 axially extends into the interior surface 94 of spring 90′ so as to allow surface 104 to engage with the abutting end of spring 90 while the radial shoulder 110 on projection 108 effects alignment of spring 90 relative to the elongated axis 64 of the respective spring assembly. Similarly, projection 118 on member 100 will axially extend into the interior surface 94 of spring 90′ so as to allow surface 106 to engage with the abutting end of spring 90′ while the radial shoulder 120 on projection 118 effects alignment of spring 90′ relative to the elongated axis 64 of the respective spring assembly.

During operation of the plow assembly 10, and in the event the plow blade 40 strikes an obstruction, forward rotation or roll of the upper portion of the blade 40 about axis 50 temporarily lengthens the connector 66 and blade 40 is moved toward the blade tripped position schematically represented in FIG. 4. As such, and as schematically shown in a comparison of FIGS. 3 and 4, the axial distance between the first and second stops 80 and 84 is shortened resulting in compression of the springs 90, 90′ of each spring assembly 62 of the biasing structure 60. Notably, however, and to optimize spring performance and operation, although the springs 90, 90′ are compressed, the alignment member 100 slides along the length of the connector whereby maintaining the inner ends of the springs 90,90′ in generally axial alignment with each other and relative to the elongated axis 64 of the respective spring assembly 62. After the obstruction is overcome, the forces acting to displace the blade to the tripped position are overcome by the spring assemblies comprising biasing structure 60. That is, the forces applied by the spring assemblies of the biasing structure 60 tend to forcibly return or restore blade 40 to the blade return position (FIG. 3).

It may therefore be appreciated from the above detailed description of the preferred embodiment of the present invention disclosure that it teaches a biasing structure having two axially arranged spring assemblies each of which includes a plurality of axially disposed springs and an alignment guide for maintaining adjacent inner ends of the springs 90, 90′ in generally aligned relation relative to each other and relative to an elongated axis of the spring assembly. In one form, the biasing structure is used to return a plow blade from a blade tripped position to a blade return position with consistency and regularity. The use of two springs arranged in end-to-end relation relative to each other economizes on the cost to manufacture the spring assembly without detracting from its performance. In most applications, Applicants have advantageously discovered it is more economical to use two shorter length springs in end-to-end combination relative to each other rather than having to manufacture a one-piece spring having the same effective length. Moreover, constructing such spring assemblies with two elastomeric end-to-end springs renders a design which is both durable and long lasting while requiring minimal maintenance in a myriad of different ambient weather conditions. Additionally, the ability to change the force required to move or roll the plow blade to a blade tripped position can be adjusted both readily and inexpensively by simply changing one or both of the elastomeric springs comprising the biasing structure.

From the foregoing, it will be observed that numerous modifications and variations can be made and effected without departing or detracting from the true spirit and novel concept of this invention disclosure. Moreover, it will be appreciated, the present disclosure is intended to set forth an exemplification which is not intended to limit the disclosure to the specific embodiment illustrated. Rather, this disclosure is intended to cover by the appended claims all such modifications and variations as fall within the spirit and scope of the claims.

What is claimed is:

1. An axially elongated spring assembly for releasably maintaining a plow blade in a predetermined position about a generally horizontal axis, said spring assembly comprising:
an elongated retractable/extendable connector arranged in general coaxial alignment with an elongated axis of said spring assembly, with a first end of said connector being operably connected to said plow blade and a second end being operably connected to a plow blade frame;
two springs arranged axially relative to each other between the first and second ends of and along said elongated guide; and
an alignment member disposed between adjacent ends of said two springs, with said alignment member defining a generally centralized opening adapted to slidably move along and relative to said elongated guide so as to align the opposed ends of said two springs relative to each other and relative to an elongated axis defined by said elongated connector.

2. The spring assembly according to claim 1 wherein, each spring is formed from an axially elongated one-piece elastomeric material defining an elongated bore opening to opposed ends thereof.

3. The spring assembly according to claim 2 wherein, the elongated bore defined by each spring has a closed margin about a diameter thereof.

4. The spring assembly according to claim 2 wherein, each spring has a plurality of axially spaced flange sections along a length thereof, with any two axially adjacent flange sections on each spring being axially separated by an axially elongated energy absorption section for allowing each spring to react to energy imparted thereto during operation of said spring assembly.

5. The spring assembly according to claim 1 wherein, said alignment member defines an opening extending therethrough, with a marginal edge of said opening having a cross-sectional configuration which proximates a cross-sectional configuration of said elongated connector.

6. The spring assembly according to claim 1 wherein, each of said springs has interior and exterior surfaces

7. The spring assembly according to claim 1 wherein, said alignment member has a body portion with projections axially extending away from opposed and generally parallel surfaces on said body portion and arranged in generally concentric relation with the elongated axis defined by said spring assembly.

8. The spring assembly according to claim 7 wherein, each projection on said alignment member defines an exterior surface sized to axially extend within the interior surface of a respective spring to affect alignment between the opposed ends of said two springs relative to each other and relative to the elongated axis defined by said spring assembly

9. In a plow blade assembly having a frame defining a longitudinal axis, with said frame mounting a plow blade for movement about a generally horizontal axis between a blade return position and a blade tripped position, and biasing structure for urging said plow blade from said blade tripped position toward said blade return position, said biasing structure comprising:
a pair of laterally spaced spring assemblies disposed to opposed lateral sides of the longitudinal axis defined by said frame, with each spring assembly including an extendable/retractable connector defining an elongated axis and having a first end operably joined toward a first end above the horizontal axis of said plow blade and a second end operably joined to said frame, first and second springs arranged in operable combination with and along a lengthwise portion of said connector for biasing said plow blade from said blade tripped position toward said blade return position, and an alignment member disposed between said first and second compression springs for axially aligning the adjacent ends of said springs relative to each other and relative to the elongated axis of said connector, with said alignment member defining a generally centralized opening for allowing said alignment member to slidably move along and relative to said connector.

10. The plow blade assembly according to claim 9, wherein the spring of each spring assembly is formed from an axially elongated one-piece elastomeric material defining an elongated bore opening to opposed ends thereof.

11. The plow blade assembly according to claim 10 wherein, the elongated bore defined by the spring of each spring assembly has a closed margin about a diameter thereof.

12. The plow blade assembly according to claim 10 wherein, the spring of each spring assembly has a plurality of axially spaced flange sections along a length thereof, with any two axially adjacent flange sections on each spring being axially separated by an axially elongated energy absorption section for allowing each spring to react to energy imparted thereto during operation of said spring assembly.

13. The plow assembly according to claim 9 wherein, the alignment member of each spring assembly defines an opening extending therethrough, with a marginal edge of said opening having a cross-sectional configuration which proximates a cross-sectional configuration of the respective elongated connector.

14. The plow assembly according to claim 9 wherein, the spring of each spring assembly has interior and exterior surfaces

15. The plow assembly according to claim 9 wherein, the alignment member of each spring assembly has a body portion with projections axially extending away from opposed and generally parallel surfaces on said body portion and arranged in generally concentric relation with the elongated axis defined by the respective spring assembly.

16. The plow assembly according to claim 15 wherein, the projection on the alignment member of each spring assembly defines an exterior surface sized to axially extend within the interior surface of a respective spring for effecting alignment between the adjacent ends of the two springs of the respective spring assembly relative to each other and relative to the elongated axis defined by said spring assembly

17. An axially elongated spring assembly defining an elongated axis, comprising:
an axially elongated multipiece connector articulately connected at a first end to a first member and articulately connected at a second end to a second member for joining and permitting pivotal movements between said first and second members;
two springs arranged axially relative to each other and along said elongated connector between the first and second ends of said guide; and
an alignment member disposed between said two springs for aligning adjacent ends of said two springs relative to each other and relative to an elongated axis of said spring assembly, with said alignment member defining a generally centralized opening adapted to slidably move along and relative to said elongated connector.

18. The spring assembly according to claim 17 wherein, each spring is formed from an axially elongated one-piece elastomeric material defining an elongated bore opening to opposed ends thereof.

19. The spring assembly according to claim 18 wherein, each spring has a plurality of axially spaced flange sections along a length thereof, with any two axially adjacent flange sections on each spring being axially separated by an axially elongated energy absorption section for allowing each spring to react to energy imparted thereto during operation of said spring assembly.

20. The spring assembly according to claim 17 wherein, said alignment member defines an opening extending therethrough, with a marginal edge of said opening having a cross-sectional configuration which proximates a cross-sectional configuration of said elongated connector.

21. The spring assembly according to claim 17 wherein, each of said springs has interior and exterior surfaces

22. The spring assembly according to claim 17 wherein, said alignment member has a body portion with projections axially extending away from opposed and generally parallel surfaces on said body portion and arranged in generally concentric relation with the elongated axis defined by said spring assembly.

23. The spring assembly according to claim 22 wherein, each projection on said alignment member defines an exterior surface sized to axially extend within the interior surface of a respective spring to affect alignment between the opposed ends of said two springs relative to each other and relative to the elongated axis defined by said spring assembly
